(19) United States
(12) Patent Application Publication
(10) Pub. No.: US 2003/0143452 A1
(43) Pub. Date: Jul. 31, 2003

(54) Conductive member, a method for manufacturing the same and a method for manufacturing a separator for use in a fuel cell

(75) Inventors: Takashi Ito, Kariya-shi (JP); Shinji Nezu, Obu-shi (JP); Ryohei Yabuno, Toyota-shi (JP); Toshihisa Terazawa, Anjo-shi (JP); Koe Nakajima, Nagoya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 10/354,021

(22) Filed: Jan. 30, 2003

(30) Foreign Application Priority Data
Jan. 30, 2002 (JP) 2002-022550

(51) Int. Cl. H01M 8/02; B28B 5/00; B32B 9/04

(52) U.S. Cl. 429/34; 264/250; 428/411.1

(57) ABSTRACT

A method for manufacturing a conductive member includes a first conductive sheet molding step by forming a conductive material to have a sheet-shaped structure, a second conductive sheet molding step by forming a conductive material to have a sheet-shaped structure, a resin sheet molding step for molding a resin sheet containing a thermoplastic resin. At least either the first conductive sheet or the second conductive sheet is porous. The method for manufacturing the conductive member further includes an adhering step for adhering the resin sheet, which is sandwiched by the first and second conductive sheets, to the first and second conductive sheets with a heat-press method. The conductive member is used as a separator for use in a fuel cell.

### CROSS REFERENCE TO RELATED APPLICATIONS

This application is based on and claims priority under 35 U.S.C. §119 with respect to a Japanese Patent Application 2002-022550, filed on Jan. 30, 2002, the entire content of which is incorporated herein by reference.

### FIELD OF THE INVENTION

This invention generally relates to a conductive member, a method for manufacturing the conductive member, and a method for manufacturing a separator for use in a fuel cell.

### BACKGROUND OF THE INVENTION

With growing concern for the environmental conservation, reduction of vehicle exhaust gas has been remarkably demanded for reducing air contamination as much as possible. An electrically powered vehicle has been resulted as one of countermeasure so far. However, there are still some to be improved in the electrically powered vehicle to be commonly popularized, which are such as charging equipments, a mileage thereof.

Meantime, a fuel cell has recently become center of public attention as a clean power generation device capable of generating electric energy by means of a reverse reaction of electrolysis using hydrogen and oxygen. Another remarkable feature of the fuel cell is that it does not discharge anything except water. Therefore, a fuel cell electric vehicle has been recently valued as an environmentally concerned vehicle with great expectations in the future. More particularly, a polymer electrolyte fuel cell (PEFC) capable of operating at relatively low temperature has been widely known as the most promising fuel cell to be applied for a vehicle.

Generally speaking, the PEFC, otherwise known as a proton exchange membrane fuel cell (PEMFC), is stacked with plural cells, each cell including an electrode unit and two separators. The electrode unit has two electrodes, which are a fuel electrode and an oxidant electrode, and a polymer electrolyte membrane (hereinafter, referred to as an electrolyte membrane), which is interposed or sandwiched between the two electrodes. The electrode unit is sandwiched by the separators. Each separator possesses gas passages for a fuel gas flow or an oxidant gas flow. More specifically, the separator for use in the fuel cell prevents the fuel gas and the oxidant gas from mixing by exposing one surface thereof to the hydrogen-containing fuel gas and the other surface thereof to the oxidant gas such as air. One of the stacked separators for the fuel cell can be designed to possess one surface to be exposed to a cooling media such as a coolant. A separator is generally designed to possess one surface with a pattern of grooves acting as the gas passages, thereby a gas flow intended by a designer can be established.

As described above, the separator for the fuel cell effectively prevents the fuel gas and the oxidant gas from mixing and establishes the intended gas flow. The separator for the fuel cell is further required to have a transmitting function of transmitting the electric power generated in the cell. Therefore, the separator for use in the fuel cell (i.e. a flat plate-shaped separator) is required to possess such following characteristics; the hydrogen gas and the oxygen can not be permeated each other via the separator (gas isolation performance), the separator can prevent the hydrogen introduced to the fuel electrode and the oxygen introduced to the oxidant electrode from mixing when the cells are stacked one another, and the separator acts as a conductor for transmitting the generated electric power through the stacked cells. Furthermore, the separator is required to possess other properties such as corrosion resistance, mechanical robustness in a thickness direction thereof. The separator with the grooves thereon is further required to possess another property that the grooves and manifolds be defined on the separator with a high dimensional precision as the gas passages or the coolant passages.

A conventional method for manufacturing a separator has been disclosed as a Japanese Patent Laid-Open No. 2001-15131. According to the disclosed method for manufacturing the separator, the separator is manufactured by sandwiching a conductive gas-isolating layer between conductive layers and by bonding the conductive gas-isolating layer with the conductive layers with a heat-press molding method. An expanded graphite sheet is applied as a material for the conductive gas-isolating layer. The conductive layers is manufactured with a conductive fabric solidified with synthetic resin.

However, the expanded graphite sheet for the conductive gas-isolating layer is a porous sheet of which density is small and cannot be easily increased. Therefore, it may be difficult to adjust a gas permeability coefficient to be smaller than a hydrogen permeability coefficient of an electrolyte membrane (1.1×10⁻¹⁶ kmol·m/(SEC·m²·kPa) in case of Nafion 117 manufactured by Du Pont Kabushiki Kaisha under a moist air). Further, when the separator with the above-disclosed structure is manufactured with the heat-press molding method, a mold for molding the separator is required to be supported while being applied with load until the synthetic resin as a binder is solidified. In this case, the mold may be easily consumed in accordance with an elongated molding time. Therefore, amortization cost for facilities may be increased, thereby resulting in raising a manufacturing cost.

Therefore, the separator is demanded to possess a higher-grade gas isolating performance, conductivity, and corrosion resistance. The separator is further demanded to possess the gas passages and the manifolds which are defined with a higher-grade dimensional precision without increasing the manufacturing cost of the separator.

Accordingly, the present invention therefore seeks to provide a conductive member with a good gas isolating performance and conductivity, a method for manufacturing the same, and a method for manufacturing a separator with a good gas isolating performance and conductivity, in which gas grooves and manifolds are defined with a high dimensional precision.

### SUMMARY OF THE INVENTION

According to as aspect of the present invention, a method for manufacturing a conductive member includes a first conductive sheet molding step of molding a first conductive sheet by forming a conductive material to have a sheet-shaped structure, a second conductive sheet molding step of molding a second conductive sheet by forming a conductive material to have a sheet-shaped structure, a resin sheet molding step of molding a resin sheet containing a thermoplastic resin, wherein at least either the first conductive sheet or the second conductive sheet is porous, and an adhering step of adhering the resin sheet, which is sandwiched by the first and second conductive sheets, with a heat-press method.

The resin sheet possesses a high mechanical robustness and a superior gas isolation performance. Therefore, the mechanical robustness of the conductive member and the gas isolation performance thereof can be improved by sandwiching the resin sheet between the first and second conductive sheets and bonding therewith. The conductive material of the conductive sheets permeates the resin sheet when being applied with a heat-pressure upon the adhering step. Therefore, the conductive materials of the first and second conductive sheets come in contact each other so that an electric current passage can be established. Therefore, as far as the compound conductive member (the conductive member) is formed with the resin sheet and the conductive sheets even if the resin sheet is an insulator, the compound conductive member can be ensured with a conductively in a thickness direction thereof substantially as much as a conductivity of a compound conductive member formed with only a conductive sheet.

When the resin sheet including a conductive particle is sandwiched between the first and second conductive sheets and is adhered therewith, the conductive material of the conductive sheet permeates the resin sheet when being applied with a heat-pressure upon an adhering step and further comes in contact with the conductive particle of the resin sheet so that an electric current passage can be established. Therefore, the conductive member can be ensured with the conductivity in the thickness direction thereof. In this case, the first and second conductive sheets are not required to become in contact with each other, thereby decreasing the applied pressure upon the adhering step comparing with the first and second conductive sheets sandwiching a resin sheet which does not include a conductive particle. Further, the first and second conductive sheets can become in contact with each other without decreasing the thickness of the resin sheet so that the conductive member can be still ensured with a high mechanical robustness in the thickness direction.

Furthermore, if a highly crystalline particle, which is of a spherical shape and is able to improve a filling factor of the resin sheet, is applied as the conductive particle for the resin sheet, the resin sheet including the conductive particle can be formed with a high molding performance.

According to another aspect of the present invention, a method for manufacturing a separator for use in a fuel cell includes a first conductive sheet molding step of molding a first conductive sheet by forming a conductive material to have a sheet-shaped structure, a second conductive sheet molding step of molding a second conductive sheet by forming a conductive material to have a sheet-shaped structure, and a resin sheet molding step of molding a resin sheet containing a thermoplastic resin. At least one of the first conductive sheet and the second conductive sheet contains a compressive conductive material of which volume is reduced by being applied with pressure. The method for manufacturing the separator further includes an adhering step of adhering the resin sheet, which is sandwiched by the first and second conductive sheets, with a heat-press method, and a groove defining step of defining a fluid passage groove on a surface of the one of the first and second conductive sheets which is opposed to an adhered surface of the one by pushing a mold possessing a reverse pattern of the groove.

The resin sheet possesses a high mechanical robustness and a superior gas isolation performance. Therefore, the mechanical robustness of the separator and the gas isolation performance thereof can be improved by sandwiching the resin sheet between the first and second conductive sheets and adhering therewith. The conductive material of the conductive sheets permeates the resin sheet when being applied with a heat-pressure upon the adhering step. Therefore, the conductive materials of the first and second conductive sheets come in contact each other so that an electric current passage can be established. Therefore, as far as the separator is formed with the resin sheet and the conductive sheets even if the resin sheet is an insulator, the separator can be ensured with a conductively in a thickness direction thereof substantially as much as a conductivity of a separator formed with only a conductive sheet.

When the resin sheet made of the thermoplastic resin including a conductive particle is sandwiched between the first and second conductive sheets and is adhered therewith, the conductive material of the conductive sheet permeates the resin sheet when being applied with a heat-pressure upon an adhering step and further comes in contact with the conductive particle of the resin sheet so that an electric current passage can be established. Therefore, the separator can be ensured with the conductivity in the thickness direction thereof. In this case, the first and second conductive sheets are not required to become in contact with each other, thereby decreasing the applied pressure upon the adhering step comparing with the first and second conductive sheets sandwiching a resin sheet which does not include a conductive particle. Further, the first and second conductive sheets can become in contact with each other without decreasing the thickness of the resin sheet so that the separator can be still ensured with a high mechanical robustness in the thickness direction.

Furthermore, if a highly crystalline particle, which is of a spherical shape and is able to improve a filling factor of the resin sheet, is applied as the conductive particle for the resin sheet, the resin sheet including the conductive particle can be formed with a high molding performance.

Still further, at least one of the first and second conductive sheets contains a compressive conductive material (i.e. a material having a compressibility) of which volume is reduced by being applied with pressure. A fluid passage groove is defined on a surface of the one of the first and second conductive sheets which is opposed to an adhered surface of the one by pushing a mold possessing a reverse pattern of the groove. Therefore, the fluid passage groove can be easily defined on the outer surface of the separator without applying a relatively large pressure. The conductive sheet including the compressive conductive material is compressed and is deformed. Therefore, the groove and an adjacent portion of the groove can be defined with a high dimensional precision and a contact flat portion, on which the groove is not defined, can be formed to be smooth. Comparing with a conventional method for defining a groove with a cutting, the manufacturing cost for defining the groove according to the present invention can be reduced and the molding time can be shortened. Therefore, the separator can be manufactured with a high productivity. Hereinafter, the material having the compressibility corresponds to a material of which volume or density is varied in response to compressive stress.

The contact flat portion is formed with the compression molding method. The contact flat portion electrically connects the separator manufactured as described above and the other separator of the other cell. The conductive sheet having the compressibility includes many small cavities so that there are small recessions and projections on a surface of the contact flat portion. According to the present invention, the recessions and projections are reduced by forming the contact flat portion with the compression molding method and the surface of the contact flat portion will become a smooth flat surface. Therefore, a contact resistance of each contact flat portion, i.e. of each separator can be reduced, thereby effectively reducing an inner electrical resistance of an entire stack having these cells.

The mold applies a pressure at a predetermined portion on the conductive sheet having the compressive conductive material and the reverse pattern of the mold is transcribed on the conductive sheet so as to define the groove pattern thereon. Compared with a conventional method for defining the fluid passage groove and so on with the cutting, the method for manufacturing the separator according to the present invention can effectively shorten the molding time and reduce the manufacturing cost for manufacturing the separator.

It is further preferable that the compressive conductive material is an expanded graphite. The expanded graphite possesses a relatively large compressibility so as to be easily compressed and deformed. The expanded graphite is superior in corrosion resistance. Therefore, the separator can be superior in the corrosion resistance. If the highly crystalline particle being in superior in the corrosion resistance is applied as the conductive particle for the resin sheet, the separator can be superior in the corrosion resistance.

Regarding the resin sheet molding step of the present invention, the melted thermoplastic resin is introduced with an air, expanded to be a balloon shape, extended to be membranous, and pressed so as to mold a thermoplastic resin substrate. In this case, the molding time for molding the thermoplastic resin to be a sheet shape can be shortened and the thickness of the resin sheet can be effectively laminated. When the resin sheet is laminated, the distance between the first and second conductive sheets can be shortened. Therefore, an electric passage can be easily established for electrically connecting the first and second conductive sheets upon the adhering step, wherein the separator can be superior in conductivity.

Further, regarding the resin sheet molding method, the melted thermoplastic resin is introduced with an air, expanded to be a balloon shape, extended to be membranous, and pressed so as to mold a sheet-shaped thermoplastic resin substrate. The sheet-shaped thermoplastic resin substrate is supplied with the conductive particle and rolled so as to mold the resin sheet. In this case, the molding time for molding the thermoplastic resin to be a sheet shape can be shortened and the thickness of the thermoplastic resin substrate can be effectively laminated. When the thermoplastic resin substrate is laminated, the distance between the first and second conductive sheets can be shortened. Therefore, an electric current passage for electrically connecting the first and second conductive sheets can be shortened. Therefore, the electric current passage for connecting the first and second conductive sheets can be easily established only by adhering the conductive particle to a surface of the thermoplastic resin substrate, wherein the separator can be superior in conductivity.

Regarding the groove defining step of the present invention, the compound conductive sheet is sandwiched by a pair of rollers. The mold is a flexible and strip-shaped member with both ends being connected so as to possess an approximately ring-shaped structure and is provided with a reverse pattern of the groove on a contact surface thereof which comes in contact with the compound conductive sheet. The mold is wound on an outer periphery of at least one of the pair of rollers and is moved in a circumferential direction of the one of the pair of rollers. The compound conductive sheet is applied with a pressure by the pair of rollers via the mold and is moved so as to define the fluid passage groove. In this case, the annular mold is arranged at a predetermined portion on the compound conductive sheet which has not been sent to the annular mold. The annular mold is pressed on the conductive sheet in response to rotation of the pair of rollers, thereby the compound conductive sheet is transcribed with the groove and is fed substantially at the same time. Therefore, the conductive sheet is compressed by the mold and is substantially simultaneously discharged after being provided with the groove. Therefore, the reverse pattern of the mold can be efficiently transcribed to the conductive sheet. Further, the reverse pattern can be continuously transcribed to the conductive sheet by sending the compound conductive sheet and the separator can be continuously manufactured. Furthermore, plural groove patterns can be transcribed to the conductive sheet by use of the same pair of rollers only by changing the mold to the other mold. Therefore, according to the present invention, a separator having a different type of groove pattern can be manufactured without a major change of the manufacturing apparatus.

Further, regarding the groove defining step of the present invention, the compound conductive sheet is sandwiched by a pair of rollers. The mold is an approximately plate-shaped mold possessing the reverse pattern of the groove on one surface thereof and is arranged on the compound conductive sheet behind at least one of the pair of rollers in a feeding direction thereof. The mold is moved to a portion between the pair of rollers with the compound conductive sheet in response to rotation of the pair of rollers and is applied with a pressure so as to define the fluid passage groove. In this case, the mold is arranged at a predetermined portion on the conductive sheet which has not been sent to the pair of rollers. The conductive sheet is pressed bye the mold in response to rotation of the pair of rollers and is sent in a rolling direction of the rollers being transcribed with the groove. Accordingly, the conductive sheet is compressed by the mold and is substantially simultaneously discharged after being provided with the groove. Therefore, the reverse pattern of the mold can be efficiently transcribed to the conductive sheet. Further, the reverse pattern can be continuously transcribed to the conductive sheet by sending the compound conductive sheet and the separator can be continuously manufactured. Furthermore, plural groove patterns can be transcribed to the conductive sheet by use of the same pair of rollers only by changing the mold to the other mold. Therefore, according to the present invention, a separator having a different type of groove pattern can be manufactured without a major change of the manufacturing apparatus.

### BRIEF DESCRIPTION OF THE DRAWING FIGURES

The foregoing and additional features and characteristics of the present invention will become more apparent from the following detailed description considered with reference to the accompanying drawing figures wherein:

FIGS. 1(a), 1(b), and 1(c) are schematic cross-sectional views of a separator for use in a fuel cell according to an embodiment of the present invention;

FIGS. 2(a) and 2(b) are schematic views of an electric current passage in the separator illustrated in FIGS. 1(a), 1(b), and 1(c);

FIG. 3 is a schematic view illustrating a method for manufacturing the separator for use in the fuel cell;

FIG. 4 is a schematic view illustrating another method for manufacturing the separator for use in the fuel cell;

FIG. 5 is a schematic view illustrating still another method for manufacturing the separator for use in the fuel cell;

FIG. 6(a) is a schematic view illustrating a groove defining step for defining a groove on the separator for use in the cell;

FIG. 6(b) is a schematic view illustrating an outer periphery of a roller for use in the groove defining step;

FIG. 6(c) is a schematic view illustrating an inner periphery of an annular mold for use in the groove defining step;

FIG. 7(a) is a front view illustrating an outer periphery of the annular mold;

FIG. 7(b) is a cross-sectional view taken along a line A-A-in FIG. 7(a);

FIG. 7(c) is a cross-sectional view taken along a line B-B in FIG. 7(a); and

FIG. 7(d) is a cross-sectional view taken along a line C-C in FIG. 7(a).

### DETAILED DESCRIPTION OF THE INVENTION

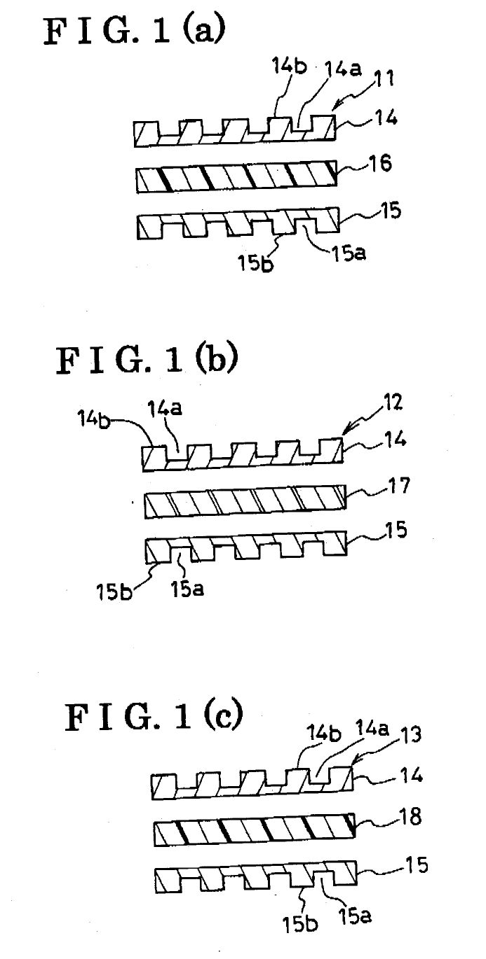

Hereinafter, a detailed description of a preferred embodiment of the present invention will now be given, referring to the accompanying drawings. As especially seen in FIG. 1(a), a separator 11 is manufactured by interposing a molded carbon sheet (a conductive resin sheet) 16 between a pair of conductive expanded graphite sheets (first and second conductive sheets) 14 and 15 and by bonding these three sheets 14, 15, and 16 with a heat-press molding method. A thermoplastic resin sheet containing conductive particles is applied for the molded carbon sheet 16 possessing a conductivity and a gas-isolating performance.

An expanded graphite is applied as a material for each expanded graphite sheet 14 and 15. The expanded graphite is manufactured with natural graphite as a row material. The natural graphite is treated with strong acid and oxidant, rinsed in water, dried at an atmospheric pressure, and applied with heat-treatment. The natural graphite applied with the aforementioned treatment is expanded with decomposition gas generated from acid, thereby the expanded graphite can be manufactured.

The expanded graphite is described in detail hereinbelow. A graphite crystal includes hexagonal networks of carbon atoms in planar layers, i.e. planer layers formed of hexagonally six-membered carbon atom rings. The planer layers are stacked and bound by a relatively weak van der Waals force. The atoms are chemically stable relative to most of chemicals. A graphite interlayer chemical compound is generated with acid, halogen, halogenide, and alkali metal between each planer layer of the graphite crystal treated with the acid. The expanded graphite is manufactured by a method for rapidly heating up and resolving the graphite interlayer chemical compound at a relatively high temperature and for expanding each interlayer space of the graphite in a substantially vertical direction relative to each planar layer with gasified inner pressure of the decomposition product. The expanded graphite is black, powdery, and vermicular with extremely small density. According to the most commercially implemented method for manufacturing the expanded graphite, natural lepidic graphite is applied with an oxidation-treatment with inorganic acid such as vitriolic acid or nitric acid, and oxidant such as perchloric acid or hydrogen peroxide. An acid graphite interlayer chemical compound is then produced, in which acid is interposed between each layer, rinsed in water, and dried. The acid graphite interlayer chemical compound is further rapidly heated up at a relatively high temperature of substantially equal to or greater than 700° C., thereby manufacturing the expanded graphite.

A material of the molded carbon sheet 16 is composed with a conductive graphite (graphite particles) and a thermoplastic resin of which composition is set to a range of 5/95 at wt % to 95/5 at wt %. The molded carbon sheet 16 can be ensured with optimal gas-isolation performance and conductivity by being composed with the thermoplastic resin and a material such as lepidic graphite, laminated graphite, or highly crystalline graphite or by being composed with the thermoplastic resin and the plural materials thereof. A preferable graphite particle diameter is set to 1 to 150 μm. When the particle diameter is substantially smaller than 1 μm, the graphite can not be properly ground by a screw of a molding machine upon manufacturing the molded carbon sheet 16 with an extrusion molding method. Therefore, the graphite may be leaked from a nozzle before being blended with the resin and the composition of the molded member with the graphite and the thermoplastic resin may become an approximate value. When the particle diameter of the graphite is substantially greater than 150 μm, the graphite may be stuck to the screw of the molding machine and the graphite may be further compressed and stuck between the screw and a cylinder, thereby the step for forming the molded carbon sheet 16 may become difficult. Therefore, it is, preferable to adopt a carbon with a spherical-shaped structure and with a high filling factor so as to improve the molding performance for molding the molded carbon sheet 16. This type of carbon can be manufactured by adding the highly crystalline graphite, which is set to approximately 70 to 100 at wt % of the compounded graphite relative to the entire composition, into the composition of the resin and the graphite.

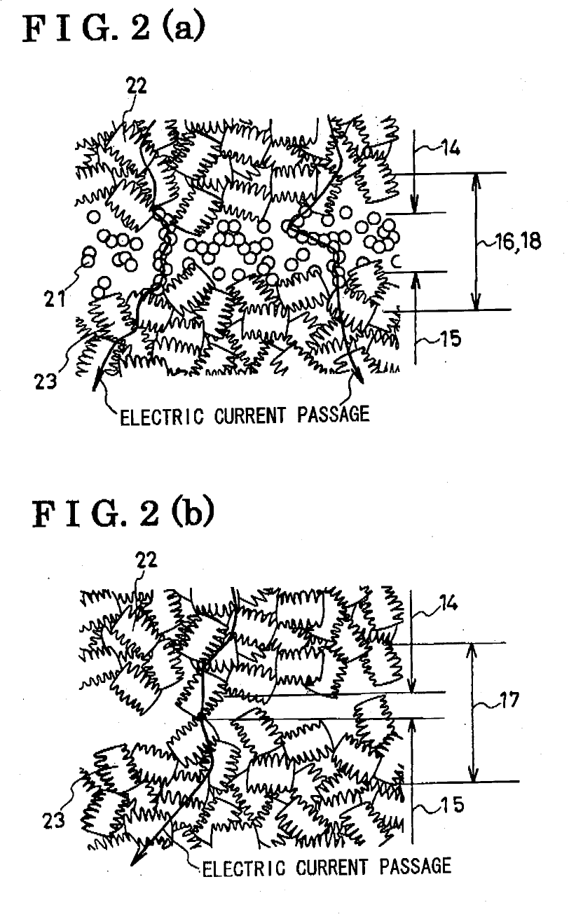

As especially seen in FIG. 2(a), when the molded carbon sheet 16 is sandwiched between the expanded graphite sheets 14 and 15 and adhered therewith with the heat-press molding method, an electric current passage can be established with graphite particles (conductive particles) 21 which partially and mutually become in contact therewith in the molded carbon sheet 16. Further, the thermoplastic resin contained in the molded carbon sheet 16 may permeate into the expanded graphite sheets 14 and 15 so that the expanded graphite particles (conductive materials) 22 and 23 in the sheets 14 and 15 become in contact with the graphite particles 21 in the molded carbon sheet 16. Therefore, the entire conductivity of the separator 11 possessing three sheets 14, 15, and 16 can be maintained substantially equal to a conductivity of a separator formed with an expanded graphite sheet itself. The expanded graphite particles 22 of the expanded graphite sheet 14 are not required to become in contact with the expanded graphite particles 23 of the expanded graphite sheet 15. The separator 11 can be hence manufactured with the molded carbon sheet 16 having a thickness which is less reduced comparing with a thickness of a thermoplastic resin sheet (a resin sheet, described later) 17. Therefore, the molded carbon sheet 16 adhered with the expanded graphite sheets 14 and 15 can be ensured with a greater mechanical robustness in a thickness direction than a robustness of the thermoplastic resin sheet 17, thereby effectively improving a robustness of the entire separator 11.

As especially seen in FIG. 1(b), a separator 12 is manufactured by interposing the thermoplastic resin sheet (the resin sheet) 17 between the pair of conductive expanded graphite sheets (the first and second conductive sheets) 14 and 15 and by bonding these three sheets 14, 15, and 17 with the heat-press molding method. The thermoplastic resin sheet 17 possesses a gas-isolation performance. A thermoplastic resin applied for the thermoplastic resin sheet 17 as a material is not limited to only one type as far as being capable of enduring under any environments in which the separator 12 is used and being kneaded with a high efficient. For example, the thermoplastic resin sheet 17 can be made of such various thermoplastic resins as polyamide resin, which includes polyethylene, polypropylene, polystyrene, acrylonitrile-butadiene-styrene resin (ABS resin), nylon 6, nylon 66, nylon 46, deformation nylon ST, and nylon MXD 6, fluorocarbon resin, which includes polyacetal, polycarbonate, metamorphic polyphenylene ether, polybutylene terephthalate, polyethylene terephthalate, polycyclohexylene terephthalate, polyphenylene sulfid, polythionic ether sulfone, thermoplastic polyimide, polyether ether ketone, polyether nitryl, polsulfone, polyether sulfone, polyetherimide, liquid crystal polymer, and polytetrafluoroethane, and thermoplastic elastomer, which includes polyester-polyesterelastomer, and polyester-polyetherelastomer. Some of the above-described thermoplastic resins can be applied as the thermoplastic resin for the molded carbon sheet 16.

As especially seen in FIG. 2(b), when the thermoplastic resin contained in the thermoplastic resin sheet 17 is melted or half-melted and permeates the expanded graphite sheets 14 and 15 through ah adhering step, the expanded graphite particles (the conductive materials) 22 of the expanded graphite sheet 14 come in contact with the expanded graphite particles (the conductive materials) 23 of the expanded graphite sheet 15 so as to establish an electric current passage therein. Therefore, the conductivity of the separator 12 formed with an electrode unit possessing the three sheets 14, 15, and 17 can be maintained substantially equal to a conductivity of a separator formed with an expanded graphite sheet itself.

As especially seen in FIG. 1(c), a separator 13 is manufactured by interposing a thermoplastic compound sheet (a compound resin sheet) 18 between the pair of conductive expanded graphite sheets (the first and second conductive sheets) 14 and 15 and by bonding these three sheets 14, 15, and 18 with the heat-press molding method. The thermoplastic compound sheet 18 is made of a thermoplastic resin sheet coated with graphite (conductive particles) or a thermoplastic resin sheet mixed with graphite. The thermoplastic compound sheet 18 possesses a gas-isolation performance. Conditions of the thermoplastic resin sheet applied for the thermoplastic compound sheet 18 are substantially the same as the thermoplastic resin applied for the thermoplastic resin sheet 17. Therefore, the molding performance of the thermoplastic compound sheet 18 can be effectively improved. Further, if a composition of the graphite particles and the thermoplastic resin is set to approximately 85/15 to 95/5% at wt %, the thermoplastic compound sheet 18 can be ensured not only with the gas-isolation performance but also with a sufficient conductivity.

Next, each molding method for molding the conductive expanded graphite sheets 14 and 15, the molded carbon sheet 16, the thermoplastic resin sheet 17, and the thermoplastic compound sheet 18 is explained hereinbelow with reference to corresponding drawing.

The conductive expanded graphite sheets 14 and 15 are molded with a rolling method to have an intended thickness by use of a rolling machine, especially by use of a multistage rolling machine for efficiently discharging gas. A roller with an opening, which is capable of compressing an internal portion of each expanded graphite sheet 14 and 15, is housed in each rolling machine so as to improve a molding performance of an edge surface thereof. It is preferable that each expanded graphite sheet 14 and 15 possesses a thickness set to 2 to 5 mm and a density set to 0.2 to 0.9 g/cm³ so as to be easily permeated with the resin or so as to easily discharge air. The air was involved upon adhering the expanded graphite sheets 14 and 15 with the molded carbon sheet 16, the thermoplastic resin sheet 17, or the thermoplastic compound sheet 18 and is required to be discharged by a step following the adhering step. When each expanded graphite sheet 14 and 15 is substantially thinner than 2 mm, the resin may not be able to easily permeate each expanded graphite sheet 14 and 15. When each of them is substantially thicker than 5 mm, the air may be easily involved upon adhering the expanded graphite sheets 14 and 15 with the sheet 16, 17, or 18 through the adhering step, thereby resulting in a difficulty of gas breathing. When the density thereof is substantially smaller than 0.2 g/cm³, the air may be easily involved through the adhering step as described above in the same manner as when each of them is substantially thicker than 5 mm, thereby resulting in a difficulty of gas breathing. When the density thereof is substantially greater than 0.9 g/cm³, the resin may not be able to easily permeate each expanded graphite sheet 14 and 15 in the same manner as when each of them is substantially thinner than 2 mm.

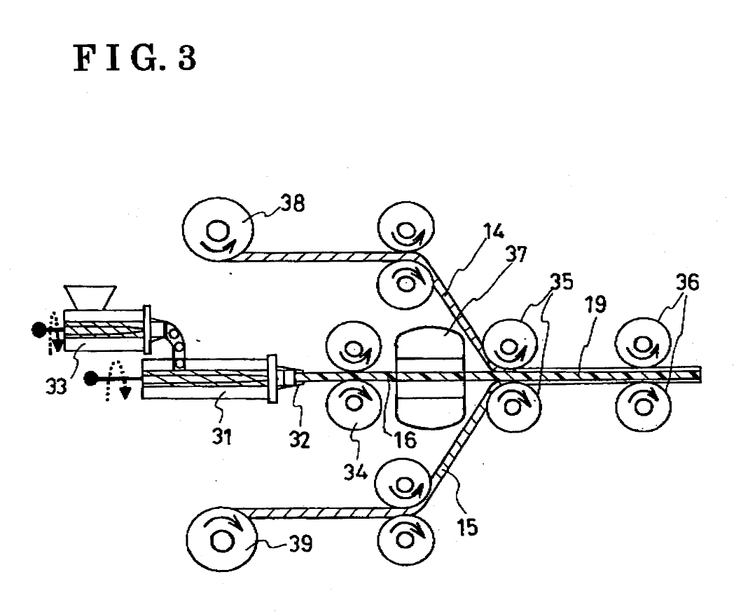

The molded carbon sheet 16 with the gas-isolation performance can be molded by compressing material injected into a mold with a flat-sheet shaped structure. However, according to the embodiment of the present invention, as illustrated in FIG. 3, the molded carbon sheet 16 is formed by use of an extruder 31, of which nozzle tip end is equipped with a T-die 32, and a biaxial extruder 33. The extruder 31 can be biaxially structured in the same manner as the biaxial extruder 33. Powder material is kneaded and granulated by the biaxial extruder 33 and is supplied to the extruder 31. The molding method by use of the extruder 31 and the T-die 32 is preferable in light of a continuous production, as illustrated in FIG. 3. A preferable thickness of the molded carbon sheet 16 is set to 0.05 to 0.5 mm in light of robustness thereof to be bonded with the expanded graphite sheets 14 and 15. When the molded carbon sheet 16 is substantially thinner than 0.05 mm, the robustness of the molded carbon sheet 16 bonded with the expanded graphite sheets 14 and 15 can not be sufficiently large so that it may be difficult in handling. When the molded carbon sheet 16 is substantially thicker than 0.5 mm, it may result in a difficult lamination of the separator 11.

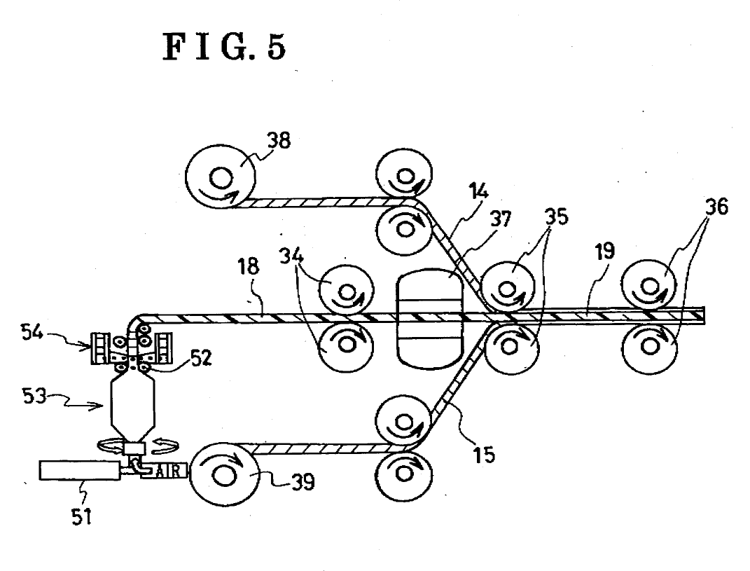

The thermoplastic compound sheet 18 can be molded by injecting powder thermoplastic resin as a row material into an extruder. However, according to the embodiment of the present invention, as illustrated in FIG. 5, the thermoplastic compound sheet 18 is formed by injecting the thermoplastic resin, which was produced by kneading and granulating the powder material by the same machine (not shown) as the kneader or the biaxial extruder 33 illustrated in FIG. 3, into an extruder 51. Accordingly, the melted and granulated resin can be continuously produced. The extruded and melted resin is introduced with air, expanded like a balloon, and rolled to be membranous by a resin sheet molding device 53. That is, the melted and granulated resin is applied with an inflation molding. The laminated resin is rolled at a predetermined thickness by a pair of thickness adjusting rollers 62 so as to mold a thermoplastic resin substrate with a sheet shaped structure. The thermoplastic resin substrate is molded being coated with graphite or with compound material of graphite and thermoplastic resin by supplying graphite particles (conductive particles) or compound material particles between the thickness adjusting rollers 52 and the thermoplastic resin substrate by a material mixer 54 when the thermoplastic resin substrate is adjusted at the predetermined thickness level. A preferable thickness of the graphite or the compound material coating an outer surface of the thermoplastic resin substrate is set to 1 to 150 μm in light of a conductivity or an adhesion strength of the separator 13 having an electrode unit of the sheets 14, 15, and 18. When the graphite or the compound material is substantially thinner than 1 μm, it may be difficult to evenly coat the surface of the thermoplastic resin substrate. Therefore, the separator 13 may not be able to be ensured with a sufficient conductivity. When the graphite or the compound material is substantially thicker than 500 μm, excessive conductive particles may be accumulated on the surface of the thermoplastic resin substrate. Therefore, the adhesion strength of the thermoplastic compound sheet 18 with the expanded graphite sheets 14 and 15 may be weakened.

The thermoplastic resin substrate for the thermoplastic resin sheet (the resin sheet) 17 can be molded in the same method as the method for molding the thermoplastic resin substrate for the thermoplastic compound sheet 18. Alternatively, the thermoplastic resin sheet 17 can be formed to be of sheet-shaped structure having an intended thickness via a T-die as illustrated in FIG. 3. A preferable thickness of the thermoplastic resin sheet 17 is set to 0.01 to 0.3 mm in light of a balance of the gas-isolation performance and a mechanical robustness in a thickness direction thereof and a conductivity of the separator 13 having an electrode unit of the sheets 14, 15, and 17. When the thermoplastic resin sheet 17 is substantially thinner than 0.01 mm, it may be difficult to completely fill in a cavity of the expanded graphite with resin. Therefore, the separator 13 may not be able to possess a sufficient gas-isolation performance and the robustness of the separator 13 may become too weak to be handled. When the thermoplastic resin sheet 17 is substantially thicker than 0.3 mm, resin layers may be easily formed on a surface of the thermoplastic resin sheet 17 so that the separator 13 may not be able to be ensured with a sufficient conductivity. When the robustness of the thermoplastic resin sheet 17 is not as sufficient as intended, the thermoplastic resin sheet 17 is adjusted to possess a predetermined robustness by being stretched.

As described above, each separator 11, 12 and 13 can be continuously manufactured by bonding the sheets 14 and 15 with either the molded carbon sheet 16, the thermoplastic resin sheet 17, or the thermoplastic compound sheet 18, which all are molded in the above-described molding methods. The method for manufacturing each separator 11, 12, and 13 can be divided into five steps such as a sheet molding step, the adhering step, a gas breathing step, a grove defining step, a separator punching step. The sheet molding step can be further divided into a first conductive sheet molding step, a second conductive sheet molding step, and a resin sheet molding step.

In order to continuously adhere the expanded graphite sheets 14 and 15 with either the molded carbon sheet 16, the thermoplastic resin sheet 17, or the thermoplastic compound sheet 18 through the adhering step, the expanded graphite sheets 14 and 15 are required to be continuously molded substantially simultaneously with either the molded carbon sheet 16, the thermoplastic resin sheet 17, or the thermoplastic compound sheet 18. According to the embodiment of the present invention, the expanded graphite sheets 14 and 15 are molded with a rolling method and the molded carbon sheet 16, the thermoplastic resin sheet 17 and the thermoplastic compound sheet 18 are formed with the extrusion molding method. The expanded graphite sheets 14 and 15 overlap either the molded carbon sheet 16, the thermoplastic resin sheet 17, or the thermoplastic compound sheet 18 and are bonded therewith through the adhering step. Each molded member (before being punched as a separator) is applied with a heat-press method by use of a rolling machine and formed with a compression molding method, thereby grooves are defined on the surface of each molded member. The grooves act as the passages for the fuel gas flow, the oxygen gas flow, the coolant, and the like. Each molded member with the grooves is then punched through the separator punching step so as to have an outer shape of the separator for an actual use in a cell.

Next, each step for manufacturing each separator 11, 12, and 13 is described in details hereinbelow.

According to the sheet molding step, the resin sheet molding step for molding either the molded carbon sheet 16, the thermoplastic resin sheet 17, or the thermoplastic compound sheet 18 is performed substantially simultaneously with the first and second conductive sheet molding steps for molding the expanded graphite sheets 14 and 15. The molded carbon sheet 16 and the thermoplastic resin sheet 17 are preferably molded in the method illustrated in FIG. 3 so as to be continuously formed. More specifically, the material kneaded by the biaxial extruder 33 is introduced into the extruder 31, is formed to possess a sheet-shaped structure by the T-die 32 equipped to the nozzle tip end of the extruder 31, and is rolled by a pair of heat-press rollers 34. The thermoplastic compound sheet 18 is preferably molded in the method illustrated in FIG. 5 so as to be continuously formed.

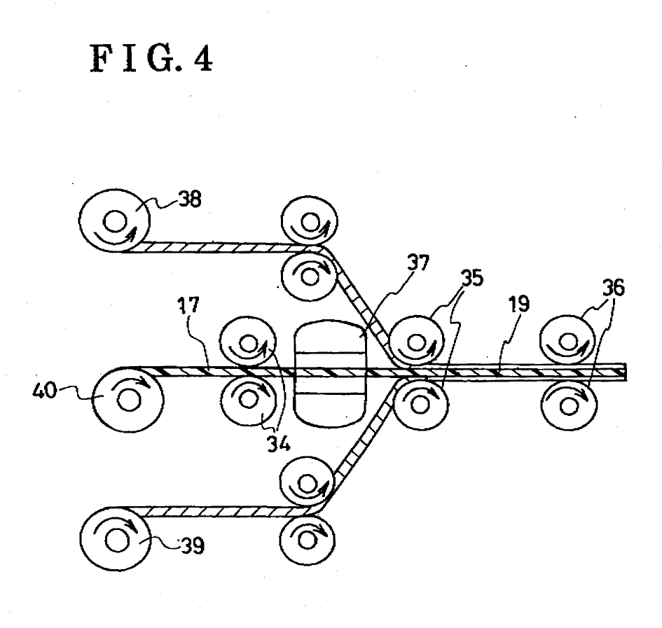

Even if the expanded graphite sheets 14 and 15 are not formed substantially simultaneously with the molded carbon sheet 16, the thermoplastic resin sheet 17, or the thermoplastic compound sheet 18, the expanded graphite sheets 14 and 15 can be alternatively manufactured by the other device in advance. As illustrated in FIGS. 3, 4, and 5, the expanded graphite sheets 14 and 15 can be wound by expanded graphite sheet rollers 38 and 39 and then sent to be bonded with either the molded carbon sheet 16, the thermoplastic resin sheet 17, or the thermoplastic compound sheet 18 through the adhering step. Further, the thermoplastic resin sheet 17 can be alternatively manufactured by the other device in advance. As illustrated in FIG. 4, the thermoplastic resin sheet 17 is wound by a thermoplastic resin sheet roller 40 and then sent to be bonded with the expanded graphite sheets 14 and 15 through the adhering step. The molded carbon sheet 16 and the thermoplastic compound sheet 18 can be alternatively manufactured in the same manner as the thermoplastic resin sheet 17 described above. The molded carbon sheet 16, the thermoplastic resin sheet 17, and the thermoplastic compound sheet 18, which all are manufactured as described above, are respectively rolled by the pair of heat-press rollers 34 and are respectively sent to be bonded with the expanded graphite sheets 14 and 15 with the adhering step.

Through the adhering step according to the embodiment of the present invention, the expanded graphite sheets 14 and 15 are arranged to overlap each surface of either the molded carbon sheet 16, the thermoplastic resin sheet 17, or the thermoplastic compound sheet 18 and are bonded therewith with the heat-press molding method, thereby forming a compound conductive sheet (a conductive member) 19. In this case, the molded carbon sheet 16, the thermoplastic resin sheet 17, and the thermoplastic compound sheet 18 are required to be applied with an optimal heat so as not to exfoliate the expanded graphite sheets 14 and 15 from the molded carbon sheet 16, the thermoplastic resin sheet 17, or the thermoplastic compound sheet 18 and so as not to deform the molded carbon sheet 16, the thermoplastic resin sheet 17, or the thermoplastic compound sheet 18. For example, the molded carbon sheet 16, the thermoplastic resin sheet 17, and the thermoplastic compound sheet 18 are respectively applied with the optimal heat by use of a heater 37, thereby the resin thereof is melted. Accordingly, the molded carbon sheet 16, the thermoplastic resin sheet 17, and the thermoplastic compound sheet 18 can be effectively bonded with the expanded graphite sheets 14 and 15 with the adhering method. If the respective sheets 16, 17, and 18 are required to be adhered with the expanded graphite sheets 14 and 15 with a higher adhesion strength, the respective sheets 16, 17, and 18 can be heated up by use of a pair of heat-press rollers 35. In this case, each roller 35 houses a heater therein. If the resin can not be melted sufficiently to be adhered with the expanded graphite sheets 14 and 15 in the above-described method, the respective sheets 16, 17, and 18 can be further heated up by adding an external heater. The additional external heater is not limited to possess a specific heating method as far as being capable of sufficiently melting the sheets 16, 17, and 18. It is preferable that each heat-press roller 35 possesses an approximately H-shaped cross section with two openings into which a pair of rollers is inserted. According to this structure of the heat-press rollers 35, the sheet deformation at a side surface thereof can be effectively restrained, thereby improving a precision for shaping the side surface of the sheet.

According to the gas breathing step, air can be breathed or discharged from the compound conductive sheet 19 manufactured as described above by use of a pair of heat-press rollers 36. The gas breathing step is necessary for efficiently discharging gas such as air involved upon molding the compound conductive sheet 19 so as not to generate a swell on a surface of the compound conductive sheet 19. However, if the compound conductive sheet 19 is pressed with a great deal of pushing force relative to the thickness thereof before being heat-pressed by the pair of rollers 36, the grooves may not be easily defined through the groove defining step which is a following step of the gas breathing step. Therefore, the pair of rollers 36 preferably possesses a gap therebetween which is set to 50 to 60% of the thickness of the compound conductive sheet 19 which has not been heat-pressed by the pair of rollers 36. Hereinafter, the gap between a pair of rollers is referred to as a roller gap if the gas is not sufficiently discharged with an only heat-press operation by the pair of rollers 36 and the swell is still remained thereon, it is preferable to employ a multistage rolling machine having plural pairs of rollers 36. In this case, the roller gaps of the respective pairs of rollers 36 are decreased in stages so as to generate the total roller gap, which is set to 50 to 60% of the thickness of the compound conductive sheet 19 which has not been heat-pressed by the pair of rollers 36. For example, when the thickness of the compound conductive sheet 19 before being heat-pressed is substantially equal to 2 mm, an ideal roller gap corresponds to approximately 1 to 1.2 mm. The pair of rollers 36 are required to apply an optical heat to the molded carbons sheet 16, the thermoplastic resin sheet 17, and the thermoplastic compound sheet 18 so as to melt or half-melt the resin used for the thermoplastic resin substrate thereof, thereby preventing the expansive graphite sheets 14 and 15 from exfoliating from each sheet 16, 17, and 18. Therefore, it is preferable that each roller 36 houses a heater therein in the same manner as each roller 35. If the resin can not be sufficiently melted or half-melted by the aforementioned heat-press method, the respective sheets 16, 17, and 18 can be further heated up by adding an external heater. The additional external heater is not limited to posses a specific heating method as far as being capable of sufficiently melting the sheets 16, 167, and 18.

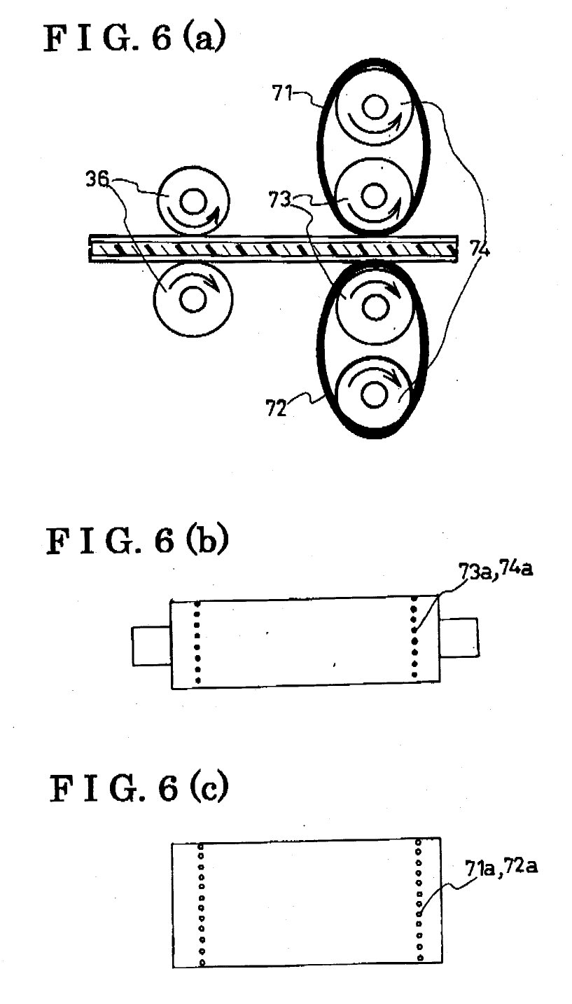

According to the groove defining step, the compound conductive sheet 19 which passed through the gas breathing step can be provided with grooves thereon with a heat-press rolling method by use of a roller unit of which outer periphery possesses a reverse pattern of a pattern of the grooves on the separator. However, according to the embodiment of the present invention, as illustrated in FIG. 6(a), the grooves are not defined by use of the aforementioned roller unit but by use of a pair of annular molds 71 and 72 arranged to sandwich the compound conductive sheet 19. Each of the annular molds 71 and 72 is formed with a flexible and strip-shaped laminate and possesses an approximately ring-shaped structure with both ends thereof being connected. Each of the annular molds 71 and 72 further possesses each reverse pattern of the grooves of each separator and of contact flat surfaces of each separator. Each of the annular molds 71 and 72 is wound on outer peripheries of a pair of rollers 73 and 74, applies pressure on the compound conductive sheet 19 which had passed through the gas-breathing step by the pair of rollers 36, and is moved for defining the grooves on the compound conductive sheet 19 in response to rotation of the pair of rollers 73 and 74.

As especially seen in FIG. 6(b), convex portions 73a, which respectively have projections of approximately 0.2 mm, are provided with an interval of approximately 0.5 mm at portions which are approximately 0.5 mm inside from side edge portions of the outer periphery of each roller 73. Convex portions 74a are provided on each roller 74 in the same manner as the convex portions 73a on each roller 73. As especially seen in FIG. 6(c), concave portions 71a, which respectively have recesses of approximately 0.2 mm, are provided at portions corresponding to the convex portions 73a and 74a at an inner periphery of the annular mold 71. Concave portions 72a are provided at the annular mold 72 in the same manner as the concave portions 71a of the annular mold 71. As being structured above, each annular mold 71 and 72 can be prevented from being dropped from the pair of rollers 73 and 74 and the pair of rollers 73 and 74 can be also prevented from idly rotated relative to each annular mold 71 and 72.

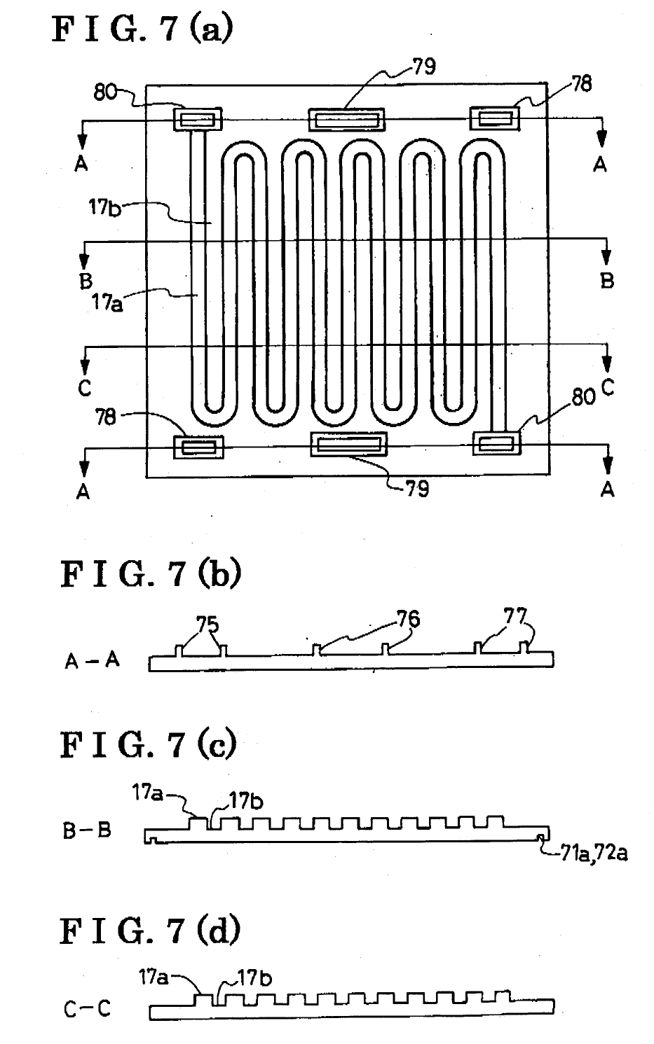

The annular molds 71 and 72 possess the reverse pattern of the grooves of the separators 11, 12, and 13. As especially seen in FIG. 7(a), an outer periphery of each annular mold 71 and 72 possesses a convex portion 17a, which corresponds to grooves 14a and 15a (shown in FIG. 1) of each separator 11, 12, and 13, and a concave portion 17b, which corresponds to contact flat portions 14b and 15b (shown in FIG. 1) which actually become in contact with an electric pole of the fuel cell or the other separator.

As especially seen in FIG. 7(b), the outer periphery of each annular mold 71 and 72 possesses projections 75, 76, and 77 for defining manifolds in each separator 11, 12, and 13. Outer peripheral structures of the manifolds on each separator 11, 12, and 13 are illustrated with reference numerals 78, 79 and 80 in FIG. 7(a). The projections 75, 76, and 77 are employed only for incising each separator 11, 12, and 13 through the groove defining step so as to easily defining the manifolds in each separator 11, 12, and 13 through the separator punching step. The fuel gas, the oxygen gas, and further the cooling media such as the coolant can be evenly supplied to all portions of the separators via the manifolds.

As described above referring to FIG. 6(c), the concave portions 71a and 72a are defined at the inner periphery of each mold 71 and 72 and at the portions corresponding to the convex portions 73a and 74a. Therefore, the concave portions 71a and 72a are illustrated in FIG. 7(c) as being taken along a line B-B of FIG. 7(a) and are not illustrated in FIG. 7(d) as being taken along a line C-C of FIG. 7(a).

An outer periphery of each separator 11, 12, and 13, the grooves as the gas passages, and the manifolds are not limited only to possess the above-described structures and patterns respectively. A number of separators are actually stacked for establishing the fuel cell. Therefore, grooves for disposing sealing members therein are required around the outer peripheral portions of the separators and of the manifolds and around adjacent portions thereof so as not to outflow the fuel gas, the oxidant gas, and the cooling media. For example, the groove for attaching the sealing member can be defined by use of at least a pair of rollers sandwiching the compound conductive sheet and at least an approximately cylindrical annular mold, which is wound on at least one of the pair of rollers. The approximately cylindrical annular mold is provided with the reverse pattern of the grooves. Therefore, the grooves can be effectively defined on at least one side of each separator.

As described above, the groove patterns are continuously defined in each separator in favor of cooperation of the annular molds 71, 72, the rollers 73 and 74. The thickness of the respective molds 71 and 72 are not specifically limited. A preferable thickness of each mold 71 and 72 is set to 0.3 to 0.7 mm in consideration of the grooves of the separator, each annular mold 71 and 72. When each mold 71 and 72 is substantially thinner than 0.3 mm, the strength of adjacent portions of the concave portions 71a and 72a may be weakened; thereby the annular molds 71 and 72 may be damaged while defining the grooves on the compound conductive sheet 19. When each mold 71 and 72 is substantially thicker than 0.7 mm, each mold 71 and 72 may be deficient in flexibility thereof and may not be able to be ensured with the annular structure. Further, the material of the molds 71 and 72 and the robustness thereof are not specifically limited unless the grooves of the compound conductive sheet 19 are deformed when being applied with pressure vie the molds 71 and 72. Still furthermore, the allocation of the rollers 73 and 74 and the number thereof are not specifically limited to the above description according to the embodiment of the present invention.

The roller gap of the rollers for use in the groove defining step is required to be set to approximately 10 to 80% of the thickness of the compound conductive sheet 19 which has passed through the gas breathing step, in light of the gas isolation performance. The molding temperature of the rollers and the structure thereof can be set to substantially in the same manner as the gas breathing step.

According to the embodiment of the present invention, the annular molds 71 and 72 are employed for defining the grooves on the separators through the groove defining step. Alternatively, the grooves can be defined by use of at least a pair of rollers sandwiching the compound conductive sheet and an approximately plate-shaped mold, which possess the reverse pattern of the grooves on one surface thereof, can be arranged on the compound conductive sheet 19 behind at least on of the pair of rollers in a feeding direction an can be moved between the pair of rollers with the compound conductive sheet in response to rotation of the pair of rollers and is applied with a hear-pressure so as to define the fluid passage groove. Further, the plural molds and plural pairs of rollers can be used for defining the grooves on both surfaces of the compound conductive sheet 19. Furthermore, the grooves can be defined on the compound conductive sheet 19 by use of a roller or plural rollers possessing the reverse pattern thereon. Still furthermore, the grooves can be defined on the compound conductive sheet 19 by use of a single shaft machine.

The compound conductive sheet 19 with the grooves is then injected into a mold possessing the structures of the manifolds and the separators and is punched with the heat-press molding method. In this case, the molded carbon sheet 16, the thermoplastic resin sheet 17, or the thermoplastic compound sheet 18 is necessarily applied with an optimal temperature for melting the resin thereof so as not to easily crack the compound conductive sheet 19. A single-shaft machine can be utilized for the separator punching step. However, a multi-shafts machine can be utilized for the separator punching step in accordance with a molding speed from the sheet molding step to the groove defining step.

Through all the above-described steps, the thickness of each separator 11, 12, and 13 can be set to approximately 1 to 2.5 mm. A preferable thickness ratio of either the molded carbon sheet 16, the thermoplastic resin sheet 17, or the thermoplastic compound sheet 18 relative to the thickness of the expanded graphite sheets 14 and 15 is set to 1/99 to 30/70 in light of the conductivity of the separator and the gas isolation performance thereof. When the thickness ratio thereof is substantially smaller than 1/99, it may be difficult to completely fill in the cavity of the expanded graphite sheets 14 and 15 with the resin of the sheet 16, 17, or 18, thereby the sufficient robustness in the thickness direction thereof may not be able to be ensured. When the thickness ratio thereof is substantially greater than 30/70, the thickness of the molded carbon sheet 16, the thermoplastic resin sheet 17, or the thermoplastic compound sheet 18 is increased. That is, the volume ratio of the resin in the separator is increased. Therefore, the adhesion of the expanded graphite and the conductive particles may be deteriorated, thereby the separator may not be able to ensured with a sufficient conductivity.

As described above, according to the embodiment of the present invention, the compound conductive sheet (the conductive member) 19 can be continuously manufactured possessing higher-grade gas isolation performance and conductivity. Further, the compound conductive sheet 19 can possess the gas passages and the manifolds, which all possesses a higher-grade dimensional precision.

According to the embodiment of the present invention, the conductive member manufactured in the above-described molding methods is applied as the separator. However, the conductive member can be applied for such products that are necessary to possess the gas isolation performance and the conductivity. For example, the conductive member manufactured as described above can be applied for manufacturing a gasket of the fuel cell.

Hereinafter, a description of several examples will now be given.

### EXAMPLE 1

The compound conductive sheet (the conductive member) 19 is manufactured by bonding the molded carbon sheet (the conductive resin sheet) 16 with the expanded graphite sheets (the conductive sheets) 14 and 15 with the heat-press rolling method.

(1) The molded carbon sheet 16 is manufactured with the composition of the graphite as highly crystalline graphite (brand name: PAG-M (hereinafter referred to as PAG-M20), manufacturer: Adchemco corporation), of which average particle diameter is set to approximately 20 μm, and the resin as polyfluovinyliden (brand name, #850, (hereinafter referred to as PVDF), manufacturer: Kureha Chemical Industry CO., Ltd.). The composition of the graphite and the resin for composing the molded carbon sheet 16 is set to 50:50 at wt %. The material with the aforementioned composition is melted and kneaded by a biaxial screw-type kneader (manufactured by Kurimoto, LTD.), which can knead the material at 230° C. and 40 rpm, so as to produce pellets with 4 mm in diameter and 0.1 to 5 mm in height. The pellets are injected into an extrusion device, which has an injection molding machine (product name: BF-150, manufacturer: Nissei Plastic Industrial Co., Ltd.) and a T-die equipped to the injection molding machine, and are extruded at a cylinder temperature of 230° C. and a screw rotational speed of 120 rpm so as to be molded with a sheet-shaped structure.

The molded member as described above is heat-pressed by a pair of flat rollers (a first pair of rollers) heated at 230° C. and another pair of flat rollers (a second pair of rollers) heated at 180° C. with the rolling method, thereby the molded carbon sheet 16 is formed with a preferable feature of 100 mm in width and 0.3 mm in thickness. In this case, the opening portion of the T-die possesses 100 mm in width and 4 mm in height, the roller gap of the first pair of rollers is set to 1.5 mm, and the roller gap of the second pair of rollers is set to 0.3 mm.

(2) The expanded graphite sheets 14 and 15 are made of expanded graphite produced from natural graphite. Next, the method for producing the expanded graphite is described hereinbelow. The natural graphite is treated with acid-treatment solution of vitriolic acid with 98% in density added with hydrogen peroxide solution with 50% in density, rinsed with water, and dried. The amount of the hydrogen peroxide solution is set to approximately 1.7 at wt % relative to the whole amount of the acid-treatment solution. The natural graphite is then heated at approximately 1000° C. for half an hour, thereby producing the expanded graphite. The expanded graphite is formed with a cold-press rolling method by use of a pair of rollers possessing a roller gap of 4 mm. Accordingly, each expanded graphite sheet 14 and 15 is formed to possess a preferable feature of 100 mm in width, 4 mm in thickness, and 0.10 g/cm³ in density. Each expanded graphite sheet 14 and 15 is wound around a roller and is molded to have 2 mm in thickness with a rolling method.

(3) The molded carbon sheet 16 manufactured in the method (1) of Example 1 is sandwiched between the expanded graphite sheets 14 and 15 manufactured in the method (2) of Example 1, supplied to a pair of rollers, and adhered therewith with a heat-press rolling method so as to form the compound conductive sheet 19 with a preferable feature of 100 mm in width and 2 mm in thickness. In this case, the compound conductive sheet 19 is molded under conditions of the molding temperature of 160 to 170° C., the roller gap of 2 mm, and the roller rolling speed of 10 rpm.

(4) The compound conductive sheet 19 manufactured in the method (3) of Example 1 then passes through the gas breathing step via a pair of rollers so as to possess a preferable feature of 100 mm in width, and 1.2 mm in thickness. In this case, the compound conductive sheet 19 is molded under conditions of the molding temperature of 150 to 160° C., the roller gap of 1.2 mm, and the roller rolling speed of 10 rpm.

### EXAMPLE 2

The compound conductive sheet (the conductive member) 19 is manufactured by bonding the molded carbon sheet (the conductive resin sheet) 16 with the expanded graphite sheets (the conductive sheets) 14 and 15 with the heat-press molding method.

(1) The compound conductive sheet 19 according to the example 2 is manufactured in the same manner as Example 1, except for the graphite for molding the molded carbon sheet 16. The molded carbon sheet 16 according to Example 2 is manufactured with the resin and a composite graphite material of PAG-M20 and laminated graphite (approximately 20 μm in average particle diameter, brand name: GR-15 (hereinafter referred to as GR-15), manufacturer: Nippon Graphite Industries, ltd.). The composition of the PAG-M20 and the GR-15 is set to 70:30 at wt %. The composition of the graphite and the resin (PVDF) for composing the molded carbon sheet 16 is set to 50:50 at wt %. The molded carbon sheet 16 is formed to have a preferable feature of 0.3 mm in thickness in the same method as the method (1) of Example 1.

(2) The expanded graphite sheets 14 and 15 are molded in the same method as the method (2) of Example 1.

(3) Accordingly, the molded carbon sheet 16 molded in the method (1) of Example 2 and the expanded graphite sheets 14 and 15 molded in the method (2) thereof is molded in the same methods as the methods (3) and (4) of Example 1 for manufacturing the compound conductive sheet 19 with a preferable feature of 100 mm in width and 1.2 mm in thickness.

### EXAMPLE 3

The compound conductive sheet (the conductive member) 19 is manufactured by bonding the thermoplastic resin sheet (the resin sheet) 17 with the expanded graphite sheets (the conductive sheets) 14 and 15 with the heat-press molding method.

(1) The thermoplastic resin sheet 17 is applied with a polyfluovinyliden resin sheet wound around a roller (0.05 mm in thickness, brand name: KF sheet (hereinafter referred to as KF sheet), manufacturer: Kureha Chemical Industry Co., Ltd.).

(2) The expanded graphite sheets 14 and 15 are molded in the same method as the method (2) of Example 1.

(3) Accordingly, the thermoplastic resin sheet 17 molded in the method (1) of Example 3 and the expanded graphite sheets 14 and 15 molded in the method (2) of Example 3 is molded in the same methods as the methods (3) and (4) of Example 1 for manufacturing the compound conductive sheet 19 with a preferable feature of 100 mm in width and 0.9 mm in thickness. The roller gap of the pair of rollers used for the method (4) of Example 1 is set to 1.2 mm. However, the roller gap of a pair of rollers used for a method (3) of Example 3 is set to 0.9 mm.

### EXAMPLE 4

The compound conductive sheet (the conductive member) 19 is manufactured by bonding the thermoplastic compound sheet (the resin sheet) 18 with the expanded graphite sheets (the conductive sheets) 14 and 15 with the heat-press molding method.

(1) The material applied for the thermoplastic compound sheet 18 is the PVDF so as to form the thermoplastic resin sheet with approximately 0.05 mm in thickness with the inflation molding method. The compound of the graphite (the conductive particles) and the thermoplastic resin is supplied to both sides of the thermoplastic resin sheet by a device when the thermoplastic resin sheet is adjusted to have an intended thickness, thereby coating both sides of the thermoplastic resin sheet with the compound of 0.05 mm in thickness. Therefore, the thermoplastic compound sheet 18 is molded to have a preferable feature of 0.15 mm in thickness. In this case, the thermoplastic compound sheet 18 is required to be applied with the molding temperature of 160 to 170° C. The compound for coating the thermoplastic resin sheet is composed with the graphite (GR-15) and the resin as the PVDF of which composition is set to 90:10 at wt %.

(2) The expanded graphite sheets 14 and 15 are manufactured in the same method as the method (2) of Example 1.

(3) Accordingly, the thermoplastic compound sheet 18 molded in the method (1) of Example 4 and the expanded graphite sheets 14 and 15 molded in the method (2) thereof is molded in the same method as the method (3) of Example 3 for manufacturing the compound conductive sheet 19 with a preferable feature of 100 mm in width and approximately 1.0 mm in thickness.

### EXAMPLE 5

The grooves are defined on the expanded graphite sheets 14 and 15 after being bonded with the thermoplastic compound sheet (the resin sheet) 18.

(1) The material applied for the thermoplastic compound sheet 18 is the PVDF so as to form the thermoplastic resin sheet with approximately 0.05 mm in thickness with the inflation molding method. The compound of the graphite (the conductive particles) and the thermoplastic resin is supplied to both sides of the thermoplastic resin sheet by a device when the thermoplastic resin sheet is adjusted to have an intended thickness, thereby coating both sides of the thermoplastic resin sheet with the compound of 0.05 mm in thickness. Therefore, the thermoplastic compound sheet 18 is molded to have a preferable feature of 0.15 mm in thickness. In this case, the thermoplastic compound sheet 18 is required to be applied with the molding temperature of 160 to 170° C. The compound for coating the thermoplastic resin sheet is composed with the graphite (GR-15) and the resin as the PVDF of which composition is set to 90:10 at wt %.

(2) The expanded graphite sheets 14 and 15 are made of the expanded graphite produced in the same method as the method (2) of Example 1. The expanded graphite is formed with a cold-press rolling method by use of a pair of rollers possessing a roller gap of 4 mm. Accordingly, each expanded graphite sheet 14 and 15 is formed to possess a preferable feature of 100 mm in width, 4 mm in thickness, and 0.10 g/cm³ in density. Each expanded graphite sheet 14 and 15 is wound around a roller and is molded to have 2 mm in thickness with a rolling method.

(3) The thermoplastic compound sheet 18 molded in the method (1) of Example 5 is sandwiched between the expanded graphite sheets 14 and 15 manufactured in the method (2) thereof, supplied to a pair of rollers, and adhered therewith with a heat-press rolling method so as to form the compound conductive sheet 19 with a preferable feature of 100 mm in width and 3 mm in thickness. In this case, the compound conductive sheet 19 is molded under conditions of the molding temperature of 160 to 170° C., the roller gap of 3 mm, and the roller rolling speed of 10 rpm.

(4) The compound conductive sheet 19 molded in the method (3) of Example 5 then passes through the gas breathing step via a pair of rollers so as to possess a preferable feature of 100 mm in width, and approximately 1.2 mm in thickness. In this case, the compound conductive sheet 19 is molded under conditions of the molding temperature of 150 to 160° C., the roller gap of 2 mm, and the roller rolling speed of 10 rpm.

(5) The compound conductive sheet 19 molded in the method (4) of Example 5 is supplied to a roll unit with the reverse pattern of the grooves on the separators. The roll unit is provided with a pair of flat rollers and an annular laminate assembled to the pair of rollers so as to be rotated together. Projections of 0.2 mm are provided with an interval of 0.5 mm at portions which are 0.5 mm inside from side edge portions of the each roller. Recessed portions of 0.2 mm are defined at portions corresponding to the projections at an inner periphery of the annular laminate which comes in contact with the flat rollers. Therefore, the annular laminate can be prevented from being dropped from the pair of rollers. Two of the aforementioned pair of rollers are employed for defining the gas passage grooves and the manifolds in both sides of the compound conductive sheet 19 with a preferable feature of 100 mm in width and approximately 1.5 mm in thickness. In this case, the compound conductive sheet 19 is molded under the conditions of the groove depth of 0.5 mm, the molding temperature 150 to 160° C., the roller gap of 1.5 mm, and the roller rolling speed of 10 rpm.

### COMPARATIVE EXAMPLE 1

The gas isolation performance of the expanded graphite is examined.

An expanded graphite sheet is manufactured in the same method as the method (2) of Example 1. The expanded graphite sheet is molded with a rolling method by use of a pair of rollers having a roller gap of 0.43 mm so as to have a preferable feature of 0.44 mm in thickness.

### COMPARATIVE EXAMPLE 2

The gas isolation performance of the expanded graphite is improved.

(1) Molding machines for molding a pair of molded carbon sheets and an expanded graphite sheet are arranged to overlap both surface of the expanded graphite sheet with the pair of molded carbon sheets.

(2) The molded carbon sheets are manufactured in the same method as the method (1) of Example 1 and the expanded graphite sheet is manufactured in the same method as the method (2) of Example 1, thereby overlapping both surface of the expanded graphite sheet with the pair of molded carbon sheets.

(3) The molded carbon sheets manufactured in the method (2) of Comparative Example 2 are adhered with the expanded graphite sheet manufactured in the method (2) of Comparative Example 2 in the same method as the method (3) of Example 1 and are discharge air in the same method as the method (4) of Example 1, thereby being molded with a preferable feature of approximately 100 mm in width and 1.0 mm in thickness. The roller gap of the method (4) of Example 1 is set to 1.2 mm. However, the roller gap of the method (3) of Comparative Example 2 is set to 1.0 mm.

### COMPARATIVE EXAMPLE 3

The gas isolation performance of the expanded graphite is strengthened.

(1) Molding machines for molding a pair of thermoplastic resin sheets and an expanded graphite sheet are arranged to overlap both surface of the expanded graphite sheet with the pair of thermoplastic resin sheets.

(2) The thermoplastic resin sheets are manufactured in the same method as the method (1) of Example 3 and the expanded graphite sheet is manufactured in the same method as the method (2) of Example 1, thereby overlapping both surface of the expanded graphite sheet with the pair of molded carbon sheets.

(3) The thermoplastic resin sheets manufactured in the method, (2) of Comparative Example 2 are adhered with the expanded graphite sheet manufactured in the method (2) of Comparative Example 2 in the same method as the method (3) of Example 1 and discharge air in the same method as the method (4) of Example 1, thereby being molded with a preferable feature of approximately 100 mm in width and 0.5 mm in thickness. The roller gap of the method (4) of Example 1 is set to 1.2 mm. However, the roller gap of the method (3) of Comparative Example 2 is set to 1.0 mm.

Evaluations

A test specimen is modeled from each compound conductive sheet manufactured in accordance with Examples 1 through 5 and Comparative Examples 1 through 3 so as to measure the gas permeability coefficient and an actual resistance.

Gas Permeability Coefficient

The test specimen with the outer diameter of φ55 mm is embedded in a sample fixture of a gas permeating device with a measuring area 13.85 cm² of the test specimen. One surface of the test specimen has an inlet portion for supplying Hydrogen thereto and an outlet portion for discharging Hydrogen. The Hydrogen to be discharged from the outlet portion is always adjusted to be 0.02 MPa by a pressure sensor equipped to the outlet portion. The other surface of the test specimen has an inlet portion for supplying Nitrogen thereto and an outlet portion for discharging Nitrogen. The outlet portion is equipped with a water condenser and a gas chromatography detector in this order and is released to the air. The Nitrogen flow volume is controlled to be 200 SCCM by a mass-flow controller. A density of the Hydrogen contained in the Nitrogen is then measured by the gas chromatography detector under the above-described conditions, thereby calculating the gas permeability coefficient of the compound conductive sheet. Regarding the compound conductive sheet according to Example 5, an outer periphery of the test specimen thereof is sealed by a silicone resin. Therefore, the gas permeability coefficient of Example 5 is calculated by actually measuring a measuring area being equal to the measuring area of 13.85 cm2 from which an area of the silicone resin is subtracted.

Actual Resistance

Both surfaces of a test specimen (40 mm in width and 40 mm in length) are in contact with electrode terminals. Each of the electrode terminals possesses a contact area of 10.8 cm2 (30 mm in width and 30.6 mm in length) which comes in contact with each surface of the test specimen so as to measure resistance in a thickness direction of the test specimen. The electrode terminals come in contact with the test specimen by means of a screw with a fastening torque 2 Nm. A measuring current is set to 10A for Examples 1 through 5 and Comparative Example 1 and 100 μA for Comparative Examples 2 and 3.

The following table 1 shows a result of the foregoing evaluations.

TABLE 1

| | Gas permeability coefficient | Actual resistance |
|---|---|---|
| | (kmol · m/(sec · m² · kPa)) | (mΩ · cm²) |
| Example 1 | 7.0 × 10⁻¹⁸ or smaller | 18 |
| Example 2 | 7.0 × 10⁻¹⁸ or smaller | 17 |
| Example 3 | 4.6 × 10⁻¹⁸ or smaller | 13 |
| Example 4 | 4.6 × 10⁻¹⁸ or smaller | 12 |
| Example 5 | 2.4 × 10⁻¹⁸ or smaller | 19 |
| Comparative Example | 2.4 × 10⁻¹³ | 6 |
| 1 | | |
| Comparative Example | 7.0 × 10⁻¹⁸ or smaller | 367 |
| 2 | | |
| Comparative Example | 4.6 × 10⁻¹⁸ or smaller | 2182 |
| 3 | | |

As described above, the gas permeability coefficients of Examples 1 through 5 are sufficiently smaller than a Hydrogen permeability coefficient of an electrolyte membrane (product name:Nafion 117, manufacturer: Du Pont Kabushiki Kaisha, approximately 10⁻⁹ kmol·m/(SEC·m2·kPa) under a moist air). The actual resistances thereof is within a range of 10 to 20 mΩ·cm2 which is a target resistance value. Therefore, the compound conductive sheets according to Examples 1 through 5 are considered to be superior in the gas isolation performance and the conductivity. On the other hand, the gas isolation performance of Comparative Example 1 is not as sufficient as the gas isolation performance of Examples 1 through 5 and the conductivity of Comparative Examples 2 and 3 is not as sufficient as the conductivity of Examples 1 through 5 and Comparative Example 1. Further, the actual resistance of Comparative Examples 2 and 3 is not within the range of the target resistance value.

According to foregoing Examples, the first conductive sheet and the second conductive sheets are applied with the expanded porous graphite sheet possessing compressibility. However, as far as at least either the first or second conductive sheet is porous, an electric passage can be established between the first and second conductive sheets with the thermoplastic resin permeated the porous conductive sheet, thereby the compound conductive sheet (the conductive member) can be manufactured.

According to Example 5, the grooves are defined on both surfaces of the compound conductive sheets, i.e. the first and second conductive sheets. However, the grooves on both surfaces thereof are not necessary and the separator can be manufactured with the grooves provided at one surface thereof. In this case, one of the first and second conductive sheets, on which the grooves are defined, can be applied with a material possessing compressibility.

As described above, the method for manufacturing the separator according to the present invention can provide a separator which is superior in the gas isolation performance, the conductivity, and the corrosion resistance and possesses gas passages and manifolds with a high dimensional precision.

The principles, preferred embodiment and mode of operation of the present invention have been described in the foregoing specification. However, the invention which is intended to be protected is not to be construed as limited to the particular embodiment disclosed. Further, the embodiment described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What we claim is:

1. A method for manufacturing a conductive member comprising:
a first conductive sheet molding step for molding a first conductive sheet by forming a conductive material to have a sheet-shaped structure;
a second conductive sheet molding step for molding a second conductive sheet by forming a conductive material to have a sheet-shaped structure;
a resin sheet molding step for molding a resin sheet containing a thermoplastic resin, wherein at least either the first conductive sheet or the second conductive sheet is porous, and
an adhering step for adhering the resin sheet, which is sandwiched by the first and second conductive sheets, to the first and second conductive sheets with a heat-press method.

2. A method for manufacturing a conductive member according to claim 1, wherein the resin sheet includes a conductive particle.

3. A method for manufacturing a conductive member according to claim 2, wherein the conductive particle is a highly crystalline particle.

4. A method for manufacturing a separator for use in a fuel cell comprising:
a first conductive sheet molding step for molding a first conductive sheet by forming a conductive material to have a sheet-shaped structure;
a second conductive sheet molding step for molding a second conductive sheet by forming a conductive material to have a sheet-shaped structure;
a resin sheet molding step for molding a resin sheet containing a thermoplastic resin, wherein at least one of the first conductive sheet and the second conductive sheet contains a compressive conductive material of which volume is reduced by being applied with pressure,
an adhering step for adhering the resin sheet, which is sandwiched by the first and second conductive sheets, to the first and second conductive sheets with a heat-press method and
a groove defining step for defining a fluid passage groove on a surface of the one of the first and second conductive sheets, which is opposed to an adhered surface of the one, by pushing a mold possessing a reverse pattern of the groove.

5. A method for manufacturing a separator for use in a fuel cell according to claim 4, wherein the compressive conductive material is an expanded graphite.

6. A method for manufacturing a separator for use in a fuel cell according to claim 4, wherein the resin sheet includes a conductive particle.

7. A method for manufacturing a separator for use in a fuel cell according to claim 6, wherein the conductive particle is a highly crystalline particle.

8. A method for manufacturing a separator for use in a fuel cell according to claim 4, wherein the melted thermoplastic resin is introduced with an air, expanded to be a balloon shape, extended to be membranous, and pressed so as to mold the resin sheet.

9. A method for manufacturing a separator for use in a fuel cell according to claim 6, wherein the melted thermoplastic resin is introduced with an air, expanded to be a balloon shape, extended to be membranous, and pressed so as to mold a sheet-shaped thermoplastic resin substrate, the sheet-shaped thermoplastic resin substrate supplied with the conductive particle and rolled, wherein the resin sheet is molded.

10. A method for manufacturing a separator for use in a fuel cell according to claim 4, wherein the compound conductive sheet is sandwiched by a pair of rollers, the mold is a flexible and strip-shaped member with both ends being connected so as to possess an approximately ring-shaped structure and is provided with a reverse pattern of the groove on a contact surface thereof which comes in contact with the compound conductive sheet, the mold is wound on an outer periphery of at least one of the pair of rollers and is moved in a circumferential direction of the one of the pair of rollers in response to rotation of the pair of rollers, the compound conductive sheet is applied with a pressure by the pair of rollers via the mold and is moved so as to define the fluid passage groove.

11. A method for manufacturing a separator for use in a fuel cell according to claim 4, wherein the compound conductive sheet is sandwiched by a pair of rollers, the mold is an approximately plate-shaped mold possessing the reverse pattern of the groove on one surface thereof and is arranged on the compound conductive sheet behind at least one of the pair of rollers in a feeding direction thereof, the mold is moved to a portion between the pair of rollers with the compound conductive sheet in response to rotation of the pair of rollers and is applied with a pressure so as to define the fluid passage groove.

12. A conductive member comprising:
a resin sheet made of a thermoplastic resin; and
a pair of conductive sheets sandwiching the resin sheet.

13. A conductive member according to claim 12, wherein the resin sheet includes a conductive particle.

14. A conductive member according to claim 13, wherein the conductive particle is a highly crystalline particle.

15. A conductive member according to claim 12, wherein the resin sheet is coated with a conductive particle.

16. A conductive member according to claim 12, wherein at least one of the pair of conductive sheets includes a compressive conductive material of which volume is reduced by being applied with a pressure.

17. A conductive member according to claim 16, wherein the compressive conductive material is an expanded graphite.
